(19) United States
(12) Patent Application Publication
(10) Pub. No.: US 2003/0202763 A1
(43) Pub. Date: Oct. 30, 2003

(54) Method for forming a protective coating on an optical fiber

(76) Inventor: Dmitry S. Starodubov, Westlake Village, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/131,970

(22) Filed: Apr. 24, 2002

(51) Int. Cl. G02B 6/22

(52) U.S. Cl. 385/128

(57) ABSTRACT

An optical fiber having a carbonized or diamond-like coating and a method for manufacturing same is provided. The carbonized or diamond-like coating is formed by modifying the polymer coatings typically used by optical fiber manufacturers to protect the optical fiber from mechanical and environmental damage. The carbonized coating is formed by heating the fiber at a controlled temperature for a predetermined period of time to carbonize the polymer layers. This carbonization results in a reduced fiber diameter resulting in excellent adhesion of the carbonized or diamond-like coating without substantially decreasing the mechanical strength of the optical fiber. The carbonized coating also assists in mounting the optical fiber, especially where adhesion of the coating to the cladding of the fiber is important, such as in a device where strain is applied to a fiber grating to tune the photosensitivity of the grating.

### FIELD OF THE INVENTION

This invention relates to optical fibers coated with an outer layer of carbonized polymer to form a diamond-like coating and a method for making the same. More specifically, the present invention relates to methods for modifying conventional polymer protective coatings typically applied to optical fibers to protect the fibers from environmental conditions to transform the original protective polymer coating into a carbonized or diamond-like coating capable of withstanding high temperatures and which provides improved adhesion of the protective coating to the optical fiber.

### BACKGROUND OF THE INVENTION

Optical fibers for use in telecommunications and applications are typically made of silica glass or plastic, but can be made of other materials. Typically, the optical fibers are doped with materials such as germanium, phosphorus, boron, fluorine and the like, to achieve a desired index of refraction in the fiber, to facilitate manufacture of the fiber, or for other purposes. As manufactured, optical fibers are relatively fragile, and require protection of the fiber from abrasion, moisture, and losses in the transmissivity of the fiber due to microbending.

Optical fibers are typically manufactured by drawing a glass perform rod vertically through a furnace at a controlled rate. The perform rod softens in the furnace and the optical fiber is drawn freely from the molten end of the preform rod.

As formed, the surface of the optical fiber is very susceptible to damage caused by abrasion and other environmental contaminants. It is thus necessary to coat the optical fiber with a protective coating after it is drawn. The coating material is typically applied in a liquid state and is cured using a variety of approaches, such as exposures to ultraviolet radiation, to harden the coating before the optical fiber is wound upon a capstan.

The strength and transmission loss in the optical fiber may be affected by the coating material. Coating defects which may expose the optical fiber to subsequent damage arise primarily from improper application of the coating material. Transmission losses may also occur in optical fibers because of a mechanism known as microbending. Optical fibers are readily bent when subjected to mechanical stresses, such as those encountered during placement in a cable or when cabled fibers are exposed to varying temperature environments or mechanical handling. If stress placed on the fiber results in a random bending distortion of the fiber axis, light propagating in the fiber core may escape from the core. Such microbending losses may be very large, and are to be avoided where possible.

For these reasons, an optical fiber, after it is drawn from a preform, is typically coated with at least one, and usually two, layers of polymer coating. These polymer layers are generally applied by directing the fiber through a reservoir containing a suitable monomer, drawing the coated fiber through a dye, and then curing the monomer into a polymer through exposure to radiation such as, ultraviolet radiation. The resulting coatings significantly enhance the mechanical and optical properties of the fiber.

Unfortunately, polymeric coatings are generally permeable to water and hydrogen, which may significantly limit the use such optical fibers in harsh environments, such as are typically found in oil field exploration and monitoring or undersea systems. Interaction of the optical fiber with permeated hydrogen attenuates the signal carried by the fiber. Interaction with water with the optical fiber typically produces surface modification to fiber that lower the fraction resistance of the fiber to apply stress. Thus, the reliability of the optical fiber, especially in adverse environments, necessitates sealing the fiber with a hermetic coating.

Heat-curable polymers, which generally break-down at temperatures typically found in many high temperature environments, have also been used to coat fibers to hermetically seal the fibers. Typically, such heat-curable polymers are heated by moving an optical fiber coated with a heat-curable liquid through an oven. In the oven, the heat-curable liquid is heated and begins to start cross-linking, or curing, starting at the surface nearest the source of heat in the oven, to form a film on the outer surface of the polymer coating. Eventually, the cross-linking, or curing, progresses through the entire thickness of the liquid to form a relatively non-permeable coating. Unfortunately, forming coatings using this method can cause bubbles to form in the uncross-linked liquid material below the film that is formed during the initial stages of heat-curing. Such bubbles are formed due to the thermal driven release of dissolved gases, volatilization of components comprising the heat-curable polymer, or volumetric changes in the coating material brought about by the thermally driven cross-linking activity. When heating is too rapid, the bubbles are permanently trapped in the solid polymer as the polymer solidifies, resulting in undesirable defects in polymeric coating and causing increased microbending loss and/or a reduction of reliability due to reduced coverage of the surface of the optical fiber.

Various methods have been used to coat optical fibers with other materials. For example, in addition to using the dual acrylate polymer coatings described above, optical fibers have also been coated with of various metals to protect the fibers from moisture and to hermetically seal the ends of the fiber. In addition, various techniques have been used to mount the optical fibers in optical electronic devices including, metal soldering, melted glass bonding, welding, or gluing. All of these techniques, however, require that the acrylate polymer coating be stripped from the optical fiber in the area where the fiber is to be mounted. Unfortunately, stripping the fiber in this manner can reduce the strength of the fiber and decrease the reliability of the final optoelectronic device.

Metal coatings applied directly to a glass optical fiber can degrade the fiber through chemical action and slip-plane intersection. Such slip-plane intersections may produce hardening at the glass-metal interface which may increase microbending losses. Accordingly, metal coatings are often applied over an organic undercoating. However, applying a metal coating to an organic layer must be done at a sufficiently low temperature so that substantial degradation of the organic layer is avoided.

Considerable effort has been expended in coating optical fibers with organic materials such as thermoplastic and ultraviolet-cured polymers to seal the optical fiber and protect it from environmental contaminants. Unfortunately, these materials, while satisfactory for a short period of time, may not provide adequate protection over the useful life of the fiber because they do not form a hermetic seal. Eventually, contaminants such as moisture or fumes may defuse through the polymer and attack the optical fiber, weakening the fiber.

Various other methods have also been used to seal fibers to protect them from environmental contamination, but have proven difficult to scale-up into viable, low cost, high speed manufacturing processes. For example, forming shielding layers using vapor-deposited chrome has been attempted. However, the layer of deposited chrome is necessarily thin because it must be vapor-deposited and as such, may not be adequately thick enough to either improve or preserve the strength of the optical fiber. Moreover, such a thin cross-section does not provide a hermetic seal, and the vapor deposition process is inherently slow.

Forming a metal cladding layer using a continuous coating process where a metal material such as aluminum or an aluminum-based alloy is deposited on the surface of a fiber optic has also been attempted. However, aluminum, and most aluminum-based alloys, are known to react with silica, causing degradation of the strength of a optical fiber over the long term.

Several non-metallic coatings have also been attempted. For example, silicon nitride has been investigated as a potential coating, but has been found to weaken the optical fiber substantially due to residual stress in the coating. Pyrolytic carbon and sputter deposited carbon have also been used as coatings for optical fibers. Neither of these materials, however, produce coatings that are hermetic to the extent required for long-term preservation of fiber strength and utility.

As described above, it is typically necessary to strip the protective polymer coatings from the fiber to securely mount the fiber to splice the fiber or connect it to an optoelectronic device. Where fibers have been metalized or coated with carbon to achieve protection of the fiber from moisture or hydrogen permeation, removing the coatings for cleaving or slicing is not a simple process. Moreover, such fibers are typically expensive, difficult to manufacture, and difficult to handle. Long pieces of metal-coated fibers typically suffer from large microbending loss, and carbon-like coatings, as described above, are generally very thin and require additional protective coatings, which must then be removed or altered for mounting the fiber. Moreover, it is difficult to splice fibers having different coatings, because such a splice produces a weak point which may affect future fiber reliability.

What has been needed and heretofore unavailable, is a loss cost, easy to manufacture, yet robust optical fiber having a carbonized coating that provides a hermetic seal and excellent handlibility, yet does not reduce the strength or reliability of the fiber. Moreover, such a carbonized coating should be amenable to mounting techniques typically used for splicing, mounting or attaching optical fibers to optoelectronic devices. The present invention fulfills these and other needs.

### SUMMARY OF THE INVENTION

The present invention is embodied in an optical fiber having a core, a cladding layer and a protective coating formed by heating an optical fiber having at least one outer protective layers of a suitable polymer for a sufficient time at a selected temperature to modify the at least one polymer layer into a carbonized or diamond-like state, and methods for forming the carbonized layer. The carbonized layer has a darker color than the original polymer layer, and has a thickness less than the thickness of the polymer layer. The carbonization of the polymer layer results in a protective layer that has increased adhesion to the underlying cladding layer of the optical fiber, while forming the protective layer does not reduce the overall strength of the fiber to an extent that the reliability of the optical fiber is impermissible reduced.

In one embodiment, an optical fiber incorporating aspects of the present invention is manufactured by heating an optical fiber, which may be commercially available, having at least one protective polymer coating, for a period of time and at a temperature selected to produce a carbonized or diamond-like coating on the outer surface of the optical fiber. The optical fiber may be heated at a temperature between approximately 210° C. to approximately 270° C. for a period of 12 to 48 hours. However, for certain polymer coatings and processing conditions, the curing time may be as short as 15-30 minutes to achieve a coating having acceptable characteristics.

In another embodiment, a fiber section of interest such as a section of the fiber containing a fiber grating may be marked before carbonization of the fiber to assist in locating a selected portion of the fiber. Marking the fiber may be accomplished using either a dye or low melting temperature material powder such as glass. The marking is visible, either because it has a different color from the carbonized coating or because it has a different reflectance that the carbonized coating.

In an alternative embodiment, the optical fiber may be heated in air, or the fiber may be heated in an environment other than air. For example, the optical fiber may be heated under nitrogen gas, or any other suitable gas. Alternatively, the optical fiber may be heated at a pressure different from 1 atmosphere, such as a reduced pressure, for example, in a vacuum, or at a pressure greater than 1 atmosphere.

In another embodiment, ends of optical fibers incorporating a carbonized or diamond-like coating formed in accordance with the present invention may be coated with a suitable material, such as a metal, to provide a hermetic seal and allow mounting of the optical fiber in a mount. Coating the ends of the optical fiber allows use of various types of solder to attach the end of the optical fiber to the mount. Alternatively, portions of the optical fiber other than the ends may be coated with a material, such as a metal or a low melt glass to allow a portion of the fiber, other than the end, to be mounted to a mount, within a device, or on a substrate. Where a low melt temperature glass or ceramic coating is applied to the optical fiber, a suitable epoxy or other type of glue may be used to mount the fiber.

In still another embodiment, optical fibers having a carbonized coating formed in accordance with aspects of the present invention may also include a fiber grating formed within a portion of the core of the fiber. Optical fibers having such fiber gratings and carbonized coatings may be mounted in a fixture or device designed to apply stress to the fiber grating portion of the optical fiber to tune the grating. The photosensitivity of the optical fiber may be altered by applying stress or strain to the fiber using the coating of the present invention. The carbonized coating is especially advantageous in such applications because of its inherently strong adhesion to the cladding of the optical fiber, allowing the optical fiber to be mounted in the fixture without requiring the coating to be stripped from the optical fiber, thus substantially reducing the possibility that the optical fiber is damaged during the mounting process.

Other features and advantages of the invention will become apparent from the following detailed description taken in conjunction with accompanying drawings, which illustrate, by way of example, the features of the invention.

### BRIEF DESCRIPTION OF THE DRAWINGS

FIG. 1 is a perspective view of a typical optical fiber coated with two protective layers of acrylate polymer;

FIG. 2 is a cross-sectional view along a longitudinal portion of an optical fiber showing an unmodified portion and a modified portion having a protective coating modified in accordance with an embodiment of the present invention;

FIG. 3 is block diagram setting forth a method in accordance with the present invention for forming the modified coating on the optical fiber of FIG. 2;

FIG. 4 is a graph illustrating coating thickness and color and strength of adhesion of the coating to the core and cladding of an optical fiber as a function of the temperature used in the process of FIG. 3;

FIG. 5 is a graph depicting the probability of failure of optical fibers treated at different temperatures to form a carbonized protective coating in accordance with the process of FIG. 3 as a function of stress applied to a fiber;

FIG. 6 is a cross-sectional side view of an optical fiber having a carbonized protective layer formed in accordance with the process of FIG. 3 mounted on an optoelectronic device; FIG. 7 is a block diagram illustrating a process for forming a fiber grating within an optical fiber and then modifying the protective polymer coating of the optical fiber in accordance with aspects of the present invention to form a carbonized protective layer on the outer surface of the fiber;

FIG. 8 is cross-sectional side view of the optical fiber manufactured using the process depicted in FIG. 7 mounted to a device for applying strain to the optical fiber to tune the optical characteristic of the grating.

FIG. 9 is cross-sectional side view of a package for a fiber device such as long-period grating based filter which requires a portion of the fiber to be sealed and mounted.

### DETAILED DESCRIPTION OF THE PREFERRED EMBODIMENTS

The present invention provides an optical fiber having core and a cladding that is coated with at leas one layer of polymer coating that is then further processed to alter the polymer coating into a carbonized or diamond-like, coating that provides a hermetic seal, maintains adequate mechanical strength in the fiber and assists in preventing transmission losses due to microbends of the fiber. Additionally a method for forming the carbonized coatings of the present invention on an optical fiber is provided.

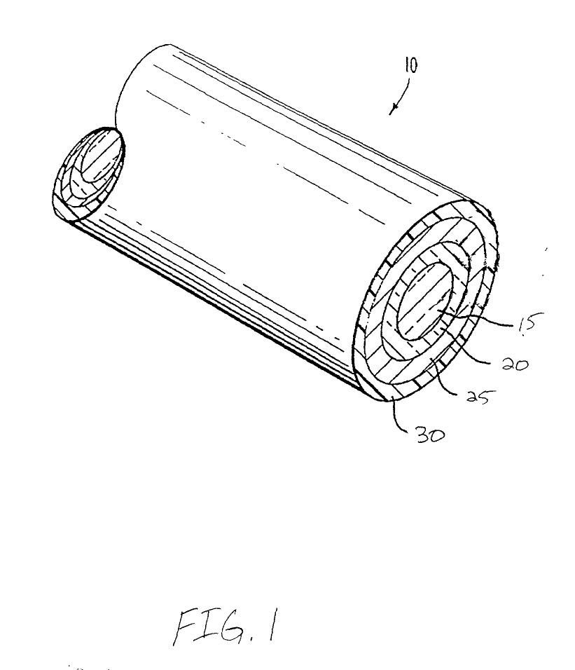

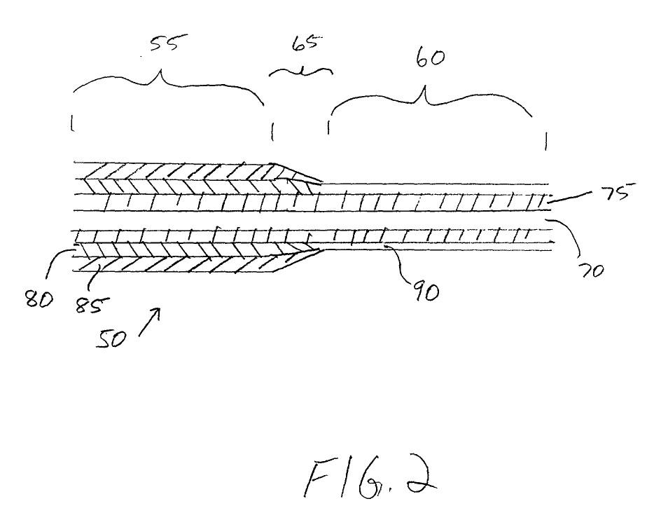

Referring now to the drawings, in which like reference numerals are used to refer to like or corresponding elements among the figures, there is generally shown in FIG. 1 a typical optical fiber 10 having a core section 15 surrounded by a cladding layer 20 that is in turn surrounded by at least one, and typically two, protective polymers coatings or layers 25 and 30. The core 15 is typically formed from high-purity SiO₂ doped silica having a first index of refraction. The cladding, or guiding layer 20 may also be formed of SiO₂ or any suitable glass material having a slightly lower index of refraction. The core 15 may have a uniform index of refraction or it may comprise two or more layers, with each successive layer being of lower index than that underlying it so as to approximate the parabolic grading of particular utility in multi-mode structures. Cladding 20 is generally of uniform composition, but also may be of graded composition.

Surrounding cladding 20 is at least one layer of glass or plastic material selected to provide mechanical and environmental protection to the core 15 and cladding 20. For example, a typical optical fiber commonly used in telecommunication applications includes a first protective layer 25 and a second protective layer 30 formed of a UV curable plastic material. Preferably, the protective layers will be formed of an acrylate-type polymer.

In use, optical fibers such as that depicted in FIG. 1 are typically mounted on substrates such as coupling devices, splices, or other fixtures designed to hold the optical fiber in place so that light from the fiber may be either guided into another fiber or into or onto an optoelectronic device. Typically the portion of optical fiber 10 to be mounted or attached to another device must have the protective coating stripped from the fiber and then be re-coated with another material, such as a metallic coating, to provide for an adequate interface to grasp, yet protect, the cladding and core of the fiber. Additionally, since the core and cladding of the fiber can be degraded by mechanical or environmental factors, such as microbending or infusion of moisture, it is useful to hermetically seal the portion of the fiber to be mounted. Unfortunately, current methods for stripping, coating, and/or hermetically sealing optical fibers are difficult and expensive and require great care in their formation to ensure reliability of the fiber and interconnection.

FIG. 2 depicts one embodiment of the present invention and shows an optical fiber 50 having a core 70 surrounded by a cladding layer 75. As depicted in FIG. 2, optical fiber has an unmodified section 55, a transition section 65, and a modified section 60. As illustrated, unmodified section 55 of fiber 50 is depicted as having a first protective layer 80 surrounding cladding layer 75, which is in turn is surrounded by second protective layer 85. After modification of the optical fiber 50, as will be described in more detail below, modified section 60 of optical fiber 50 has core layer 70 and cladding layer 75 surrounded by a carbonized or diamond-like layer 90.

It will be understood that FIG. 2 has been drawn to show the change in the various protective layers of optical fiber 50 as a result of the modification process, and thus also shows a transition section 65. Those skilled in the art will understand that while such a transition section 65 is shown, the entire optical fiber could be manufactured in such a manner as to only have modified section 60. Moreover, while the unmodified section 55 fiber 70 is depicted having two protective polymer layers surround the core and cladding layer of the fiber, it will be understood that optical fibers having only one layer of protective polymer coating may also be modified in accordance with the principles of the present invention to form a carbonized or diamond-like, coating or layer such as that depicted in modified section 60 of fiber 50 without departing from the intended scope of the present invention.

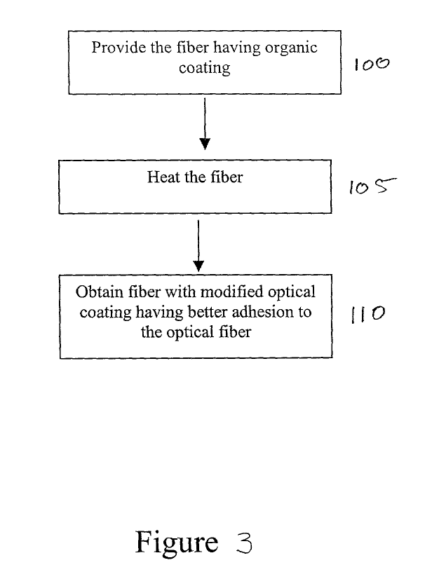

FIG. 3 is a block diagram showing an embodiment of the method for modifying the protective polymer layers of an optical fiber to form a carbonized or diamond-like coating. As shown in box 100, an optical fiber having one or more layers of organic polymer-based protective coatings is heated in a controlled manner at a predetermined temperature for a selected period of time (Box 105). Completion of the heating process results in a protective coating approximately 10-20 microns thick that may be characterized as a carbonized coating. The carbonized coating provides for improved adhesion of the coating to the core and cladding layers of the optical fiber, and also provides a moisture resistant barrier and improved mechanical protection of the optical fiber.

Previous attempts to modify organic-based protective coatings, particularly coatings using acrylate polymers, by exposing the acrylate coating to high temperatures resulted in oxidation and disintegration of the coating with subsequent weakening of the optical fiber. The process of the present invention, however, exposes the protective acrylate polymer coatings of an optical fiber to temperatures low enough to carbonize the coating without substantially degrading the strength of the fiber.

Optical fibers having acrylate protective coatings may be heated at a temperature of approximately 150° C. to 300° C., and preferably between approximately 150° C. to 250° C., to modify the acrylate polymers into a carbonized coating. Modification of optical fiber polymer protective layers in this manner typically results in a decrease in the outer diameter of the coating and the overall diameter of the optical fiber, as is shown in FIG. 2. Moreover, the modification of the protective polymer layers also causes a change in the color of the coating from initially transparent to colors ranging from yellow to black, depending upon the amount of modification of the acrylate protective coating performed.

The carbonization of the acrylate polymer protective coating in accordance with the principles of the present invention results in a carbonized protective coating that provides protection to the core and cladding layers without substantially degrading the mechanical toughness of the fiber. The reduction in diameter of the protective coating also results in an increase in the adhesion of the coating to the cladding of the optical fiber, which is advantageous in splicing, mounting or attaching the optical fiber to another fiber or optoelectronic device. Moreover, modification of the acrylate polymer coatings to provide the carbonized, diamond-like, coating of the present invention also provides for reduced outgasing and evaporation of organic species from the acrylate polymers, which may improve performance of the optical fiber in environmental conditions where outgasing of low boiling point or unpolymerized species or contaminants from within the acrylate coating may, over time, affect the performance of either the optical fiber, or the device attached, coupled to or mounted to the optical fiber.

It has been determined that the rate of formation of the carbonized protective coating is dependent on the temperature of the modification process. Moreover, controlling the rate of modification has been determined to be important to forming a carbonized protective layer having substantially uniform characteristics. For example, modifying the acrylate polymer coating or coatings of an optical fiber at temperatures of about 250° C. to about 300° C. has been found to rapidly carbonize the acrylate polymer layers, resulting in an outer layer, or skin, forming on the outer surface of the acrylate polymer layers. This skin traps outgasing or evaporating low boiling point species or absorbed contaminants beneath the skin and within the un-carbonized polymer layer, resulting in the formation of a somewhat oil liquid layer under the skin which does not adhere to the outer surface of the cladding layer of the optical fiber.

The inventor has found that modifying the acrylate polymer protective layers of an optical fiber at temperatures in the range of approximately 200° C. to about 250° C. results in a process that is analogous to slow drying of a substance and results in thin, dense and uniform carbonized or diamond-like, coating. Such a thin, dense and uniform coating readily adheres to the outer surface of the cladding layer of the optical fiber. The modification of the acrylate polymer layers of the optical fiber may be performed either in air or, alternatively, the modifications may be carried out under other environmental conditions, such as, for example, under dry nitrogen or in a vacuum or increased pressure to selectively change the properties of the final carbonized or diamond-like, coating.

The temperature of the modification process may be either constant throughout the time the optical fiber is exposed to the modification temperature, or alternatively, the temperature may be varied during the modification process, depending upon the desired characteristics of the final coating. For example, in one embodiment, the optical fiber may be initially exposed to a temperature of 210° C. The temperature is then controllably increased, or ramped, during the modification process so that the temperature reaches 240° C. after two hours. While ramping of modification temperatures may be useful, depending upon the type of acrylate polymer coating used on the optical fiber or the desired characteristics of the final coating, it will be understood that such a ramp up in temperature is not necessary to achieve the benefits of the present invention.

In one example utilizing the modification process described above, SMF 28 optical fiber manufactured by Corning Corporation was heated to a temperature of 220° C. in air. After heating the optical fiber for 48 hours at this temperature, a uniform black colored coating formed on the outer surface of the optical fiber. A decrease in diameter of the modified optical fiber was also observed, as is shown in FIG. 2. Attempts to manually strip the carbonized coating from the modified fiber failed, indicating the improved strength of adhesion of the modified coating to the optical fiber.

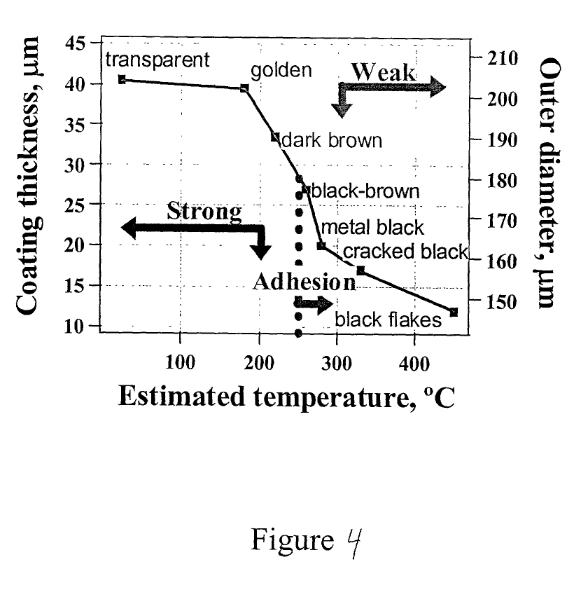

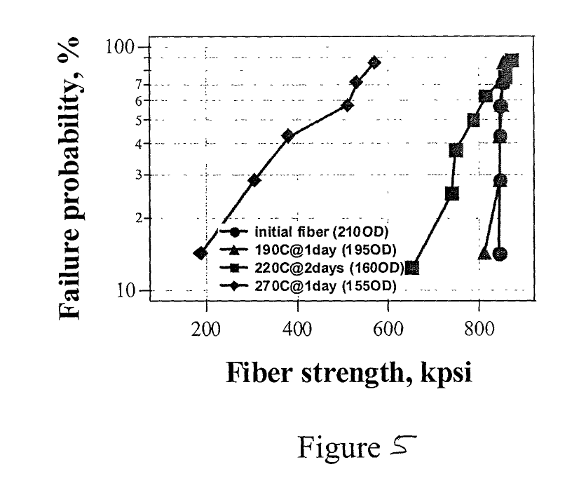

FIG. 4 is a graphical representation showing degree of modification as a function of temperature for optical fibers heated for 24 hours. As seen in FIG. 4, several characteristics of the carbonized coating formed by the modification process vary as a function of process temperature. For example, the color of fibers heated for 24 hours darkened from an initially transparent color to a golden hue to dark brown and then to black as temperature is increased. For temperatures exceeding 300° C., the color of the modified coating is either black cracked or flaked, indicating disintegration of the modified coating.

The adhesion of the modified coating to the optical fiber is also a function of temperature, when treatment time is held constant. It will also be understood that the treatment time may be varied to vary the characteristics of the modified fiber coating. For example, when the optical fiber is heated at temperatures lower than about 200° C., the carbonized coating does not adhere strongly to the optical fiber. Heating the optical fiber at higher temperatures results in improved adhesion of the coating to the optical fiber. However, heating polymer coated optical fibers above about 270° C. have been shown to result in degradation of the strength of the optical fiber.

The graph in FIG. 4 also illustrates that the thickness of the carbonized coating, and accordingly, the outer diameter of the optical fiber, also varies as a function of treatment temperature when treatment time is held constant. As shown in FIG. 4, a typical, commercially available, optical fiber having dual acrylate polymer protective coatings has an outer diameter of between 200 and 250 microns. The protective polymer coatings themselves are approximately between 40 and 45 microns in thickness before modification. As temperature is increased, the thickness of the acrylate polymer layers decreases to approximately 25 microns when the fiber is heated at a temperature approximately 270° C. for 24 hours. The outer diameter of the entire optical fiber decreases from between 200 to 210 microns to between 160 and 170 microns under those process conditions.

In FIG. 5, fiber failure probability as a function of fiber strength for an unmodified fiber and fibers modified at 190° C. for one day, 220° C. at two days, and 270° C. at one day is shown. FIG. 5 also illustrates that the outer diameter of the modified optical fiber, and also the thickness of the carbonized coating, is a function of process conditions. The graph also shows that fiber strength of fibers treated at 220° C. for two days is not significantly different from fibers treated at 270° C. for one day. Fiber strength is not degraded significantly, and mechanical adhesion of the coating to the fiber is excellent. Treating the fiber at temperatures below about 200° C. results in less degradation of strength of the fiber, however, the coating of such a fiber has been observed to be less robust than the coating formed at 220° C.

It has been determined that it is important to mount the fiber during the modification process in the heating oven or kiln to prevent the fiber from contacting other objects during the modification process. For example, attaching an optical fiber to a hot plate with Kepton™ tape creates non-uniform regions in the carbonized coating which become mechanically weak spots of the fiber. Such weak spots may adversely affect the reliability of the optical fiber during use.

It has also been observed that the carbonized coating produced in accordance with the principles of the present invention provides resistance to degradation by solvents such as acetone or fuel, such as, for example, aircraft fuel. For example, modifying the protective coating of an optical fiber at a temperature between 150° C. to 180° C. resulted in a carbonized coating having a brown coloration. The coating became softened after soaking the optical fiber for three hours in acetone, and could be easily stripped from the fiber. Testing the carbonized coating which was created by modifying optical fibers at temperatures of about 210° C. to 260° C., however, showed that soaking the fiber for an entire day in acetone did not soften the coating, and the carbonized coating was not easily removable from the optical fiber.

Although typical fiber strength decreases for modification temperatures above about 270° C., the decrease has been found to be of approximately 20 percent. The carbonized coating prepared in accordance with the present invention, however, is capable of withstanding high temperatures, such as those encountered during mounting of the optical fiber to a substrate or optoelectronic device. For example, the carbonized coating of the present invention has been found to be capable of being soldered with a standard soldering iron, where the soldering temperature may exceed 300° C. The carbonized coating of the present invention has also been found to resist degradation even when coated with low melting temperature glass at temperatures exceeding 400° C.

Fibers and fiber gratings coated with carbonized coatings in accordance with present invention may be incorporated or embedded into composite materials or structures formed from such materials. The coatings of the present invention are particularly advantageous in that they are capable of withstanding the heat and pressures commonly used during formation and manufacture of composite materials and structures. For example, an optical fiber may be embedded in a composite structure preform before curing the composite structure. Subsequent processing of the composite structure such as curing under heat and pressure would not affect the protective coating of the optical fiber. Moreover, the nature of the protective coating will typically ensure that the bond between the protective coating and composite material of the structure would strong enough to resist pull out of the fiber or other damage to the fiber resulting from further processing of the structure.

The carbonized, diamond-like coating of the present invention is particularly useful when applied to optical fibers which are subsequently spliced or mounted or attached to optoelectronic devices without compromising the mechanical reliability of the fiber. An optical fiber modified to include the novel carbonized coating of the present invention can be mounted a fixing or mounting agent such as, for example, lead-tin metal solder or other solder or mounting agent such as low melting temperature glass. For example, the coated fiber may be immersed into liquid solder and then withdrawn, resulting in a layer of solder coating the outside of the carbonized coating which is strongly adhered to the carbonized coating. Moreover, such a solder coating provides an improved hermetic seal of the fiber.

Typically, the length of optical fiber within the metal coating may be less than 1 mm, however, it has been determined that improved adhesion of the metal layer to the carbonized coating may be obtained when the metalized layer is approximately 3 mm to 1 cm in length.

Optical fibers incorporating the carbonized coating of the present invention may also be used where the mount is formed using glass or ceramics having relatively low melting temperatures. It has been found that glass melts have good adhesion to the carbonized coating. Testing has shown that glass melt coated areas of the optical fiber of less than 1 mm in length provide reliable mechanical contact and a good hermetic seal for the fiber. Seal lengths of 1 mm to 3 mm, as well as longer seals, may also be formed.

Optical fibers incorporating the carbonized coating of the present invention may also be reliably mounted using other techniques. For example, an optical fiber having a carbonized coating in accordance with the present invention may be exposed to an argon plasma to modify the surface of the carbonized coating such that the optical fiber may be reliably glued to a mount using commercially available epoxy glue.

Use of the carbonized, diamond-like coatings of the present invention is particularly advantageous in environments where reliable operation of the fiber is required and where regular fiber coatings would be degraded. For example, such environments include environments where the optical fiber is exposed to high temperatures, high humidity, solvents and/or solvent vapor, such as in fuel tanks, or in environments where the optical fiber is exposed to high levels of radiation. The carbonized, diamond-like coatings of the present invention may also be used in applications where high strain or compression stress is required to be applied to the fiber and where slippage of the fiber within the mount must be prevented to maintain reliable operation of the fiber and/or optical device. Such applications include tunable fiber Bragg grating filters which may be incorporated into, for example, tunable lasers where mechanical tuning of grating is used to change the wavelength of the light output of the laser. Because the coatings of the present invention also improve the resistance of the fiber to damage from applied strain, optical fiber coated with the carbonized, diamond-like coatings of the present invention may prove advantageous for use in applications where optical fiber must be tightly wound on a capstan or spool.

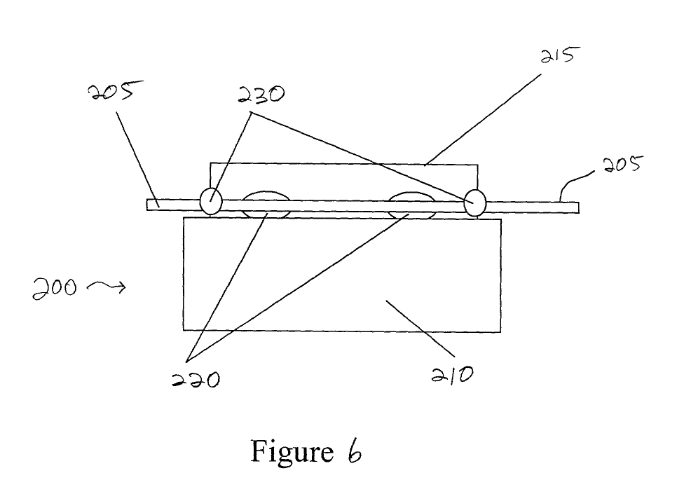

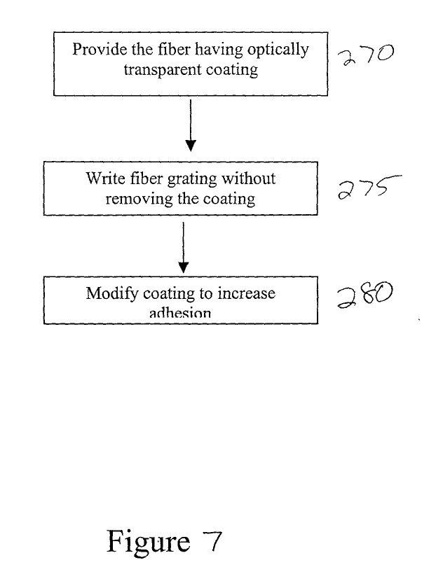

FIG. 6 shows a typical example of an optical fiber that has been mounted to a substrate. Mounts of this type may be used to hold the optical fiber, to splice two optical fibers, or to connect an optical fiber to a device that receives light transmitted through the fiber. In this figure, optical fiber 205, which includes a core section and a cladding section and has been modified to include a carbonized coating in accordance with the present invention is mounted between a substrate 210 and a cover 215 using mounting solder 220 applied at selected regions within the mounting. Alternatively the mounting solder 220 can be applied continuously along the mounted portion of the fiber 205. A hermetic seal within the length of the mounting is achieved using additional sealing solder beads 230.

FIG. 7 depicts a method for forming a fiber grating within an optical fiber and then modifying the protective coating of the optical fiber to increase adhesion of the protective coating to the core and cladding of the optical fiber so that the fiber may then be mounted in a strain or compression stress inducing device, such as a mount for mechanically tuning a Bragg grating incorporated within the fiber. In this method, an optical fiber having an optically transparent coating is provided (box 270). Using techniques such as those set forth in U.S. Pat. No. 5,469,520, incorporated herein in its entirety, a fiber grating is written within the core of the optical fiber without removing the protective acrylate based polymer coating or coatings of the fiber (box 275). The fiber grating is written within the core of the fiber by exposing the fiber to light from an appropriate laser filtered through an appropriate plastic or glass phase mask. The type of laser used is dependent upon the desired wavelength of the laser light and the pattern of the phase mask is selected in accordance with the desired photosensitivity of the fiber grating. The optical fiber having the fiber grating now incorporated therein is then heated in accordance with the methods of the present invention at a desired temperature for a selected length of time (box 280) to produce a carbonized or diamond-like coating in accordance with the present invention. The modification process parameters, such as temperature and time of heating, or heating using a desired varying temperature profile, are selected to produce carbonized coatings have characteristics desired by the designer of the device. For example, as described previously, the treatment temperature or heating profile and treatment time and/or treatment environment may be selected to provide carbonized coatings to have, for example, various colors and adhesive strengths.

In one example, a commercially available photosensitive optical fiber having a numerical aperture of 0.3 and coated with a standard dual acrylate protective coating was modified according to the process set forth in FIG. 7. In this experiment, a one centimeter long fiber grating having a reflectivity of 50 percent was fabricated through the acrylate coating, before the acrylate polymer coating was modified, using light from a 351 nm argon laser to illuminate the optical fiber through a plastic replica phase mask, as set forth in U.S. Pat. No. 5,881,186, which is incorporated herein in its entirety. After the fiber grating was formed in the core of the optical fiber, the optical fiber was heated at 210° C. for 36 hours in a vacuum. At the end of the modification process, the previously transparent acrylate protective coating of the optical fiber was observed to have a uniform black coating and a reduced diameter. The reflectivity of the fiber grating was measured to be approximately 15 percent after the modification process.

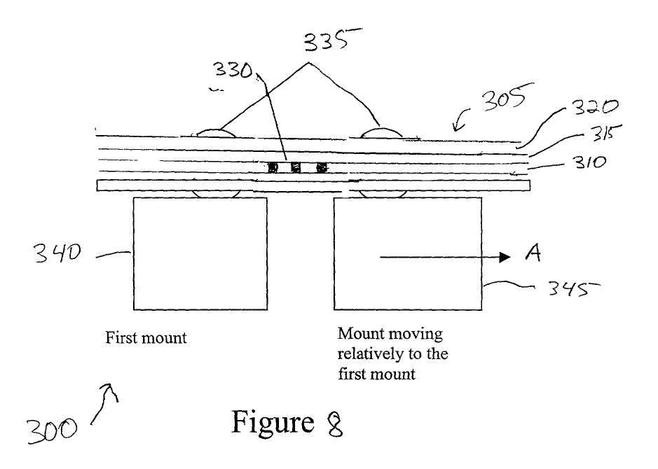

An optical fiber formed in accordance with the method illustrated in FIG. 7 may be mounted in a fixture designed to provide mechanical strain or compression stress to the fiber as is shown in FIG. 8. An optical fiber 305 having a core section 310 surrounded by cladding layer 315 which, in turn is surrounded by carbonized layer 320 formed in accordance with the methods of the present invention is mounted in strain inducing fixture 300. Optical fiber 305 also includes a fiber grating formed within the core portion 310 of optical fiber 305.

Optical fiber 305 is mounted in fixture 300 so that fiber grating 330 is situated between a fixed first mount 340 and a movable second mount 345. Optical fiber 305 is mounted to first mount 340 and second mount 345 using solder or other suitable means. Moving second mount 345 relative to first mount 340 in direction A induces strain in optical fibers 305, altering the spectral reflectivity of fiber grating 330. Moving mount 345 in a direction to direction A induces compression stress which also results in a change in the spectral reflectivity of the fiber grating. While FIG. 8 depicts second mount 345 as being capable of motion relative to first mount 340, it will be understood by those skilled in art that either first mount 340 or second mount 345, or both, may be capable of motion with respect to the other mount. It will also be understood that, while relative motion of mount 345 in relation to first mount 340 is shown in direction A, the reverse is also true. For example, second mount 345 may be moved in a direction opposite from direction A to relieve previously induced stress on the optical fiber or to induce compression stress. A device incorporating the aspects shown in FIG. 8 may be used to change the fiber's photosensitivity and tune the spectrum of the fiber grating in a number of applications. For example, the tuning of the fiber grating resulting from a change in strains induced on the fiber may be used to compensate for dispersion of light within the fiber. Moreover, a tunable fiber Bragg grating may also be used for to provide a tunable add/drop filter, or such a mount may be used to tune the output of a fiber laser. Stretching the fiber has be shown to increase the photosensitivity of the fiber and can be used for writing deeper gratings in the fiber.

For example, an optical fiber incorporating a fiber grating and a carbonized coating in accordance with the present invention was mounted using soldering mounts formed on the outer surface of the coated fiber at each end of the area of the fiber having the fiber grating formed within. The solder mounting was accomplished using standard lead-tin metal solder and the fiber was mounted to a standard circuit board. The length of the soldered regions on both sides of the grating was approximately 3 mm. A tuning range of approximately 70 nanometers was achieved using simple mechanical stretching of the optical fiber.

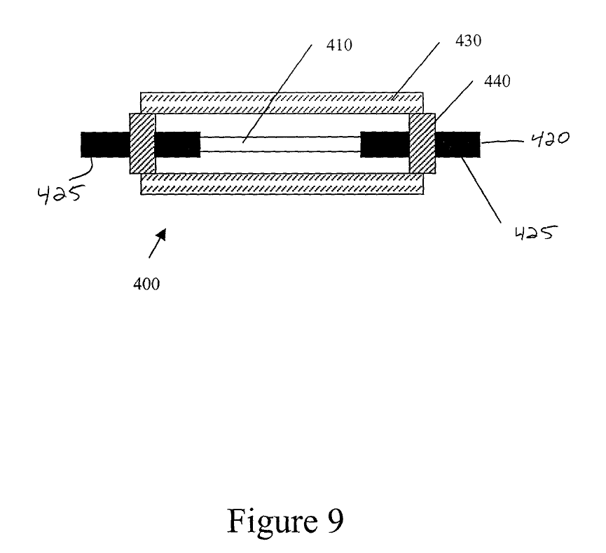

An example of packaging of optical components such as long period fiber gratings using the coatings of the present invention is shown in FIG. 9. The fiber device package 400 has a fiber 420 running through it. As shown, a portion 410 of the fiber 420 where the carbonized coating 425 of the fiber 420 is stripped away is sealed inside the package 400. The sections of the fiber 420 with carbonized coating 425 formed on the outer surface of the optical fiber in accordance with the present invention provide a strong and stable surface that is used to secure the fiber to the package. For example, solder 440 is used to couple attach the carbonized sections 425 of the fiber to the package. Solder 440 also seals the fiber within the package to prevent contamination of stripped portion 410 of fiber 420 by water vapor or other environmental contaminants.

In one embodiment, the body 430 of the package 400 is designed to have a thermal expansion coefficient selected to provide a package that either prevents the inducement of stress or strain on the fiber, or, alternatively, to controllably apply stress or strain to the fiber to alter the fiber's optical transmission characteristics. For example, in one embodiment the thermal expansion of the body 430 is matched to expansion of the fiber so that the tension of the fiber does not change with temperature. Alternatively the thermal expansion of the body 430 is selected to achieve a desired modification of the temperature dependence of device 410 using strain or stress change.

While several specific embodiments of the invention have been illustrated and described, it will be apparent that various modifications can be made without departing from the spirit and scope of the invention. Accordingly, it is not intended that the invention be limited, except as by the appended claims.

What is claimed is:

1. An optical fiber, comprising:
a core portion;
a cladding layer surrounding the core portion; and
a protective layer formed by heating at least one polymer layer surrounding the cladding layer for a selected period of time at a temperature selected such that the protective layer has a thickness less than the thickness of the at least one polymer layer.

2. The optical fiber of claim 1, wherein the polymer layer surrounding the cladding layer is heated for a time selected from the range of 4 to 48 hours.

3. The optical fiber of claim 1, wherein the polymer layer surrounding the cladding layer is heated at a temperature selected from the range of 200 degrees centigrade to 270 degrees centigrade.

4. The optical fiber of claim 1, wherein the polymer layer surrounding the cladding layer is heated at a first temperature for a first selected time and then heated at a second temperature for a second selected time.

5. The optical fiber of claim 4, wherein the temperature is controllably increased in selected increments from the first temperature to the second temperature.

6. The optical fiber of claim 1, wherein the polymer layer surrounding the cladding layer is heated in air.

7. The optical fiber of claim 1, wherein the polymer layer surrounding the cladding layer is heated in an environment other than air.

8. The optical fiber of claim 7, wherein the environment is nitrogen.

9. The optical fiber of claim 7, wherein the environment is a vacuum.

10. The optical fiber of claim 1, wherein the polymer layer surrounding the cladding layer is heated at a pressure less than atmospheric pressure.

11. The optical fiber of claim 1, wherein the polymer layer surrounding the cladding layer is heated at a pressure greater than atmospheric pressure.

12. The optical fiber of claim 1, wherein the at least one polymer layer surround protective coating has a transparent characteristic and the protective coating has a darkened characteristic.

13. The optical fiber of claim 1, wherein the at least one polymer layer is marked so that the mark can be detected on the protective layer.

14. A method of forming a protective coating on an optical fiber; comprising:
providing an optical fiber having a core portion and a cladding portion surrounding the core portion and also having at least one polymer layer surrounding the cladding portion;
heating the optical fiber for a selected time at a selected temperature to transform the at least one polymer layer surrounding the cladding portion into a carbonized protective coating.

15. The method of claim 14, wherein heating the optical fiber includes heating the fiber at a temperature selected from the range of temperatures between and including about 200 degrees centigrade to 270 degrees centigrade.

16. The method of claim 14, wherein heating the optical fiber includes heating the fiber for a selected time selected from the range of 4 hours to 48 hours.

17. The method of claim 14, wherein heating the optical fiber includes heating the fiber in air.

18. The method of claim 14, wherein heating the optical fiber includes heating the fiber in an environment other than air.

19. The method of claim 18, wherein the environment is nitrogen gas.

20. The method of claim 18, wherein the environment is a vacuum.

21. The method of claim 17, wherein the optical fiber has a first diameter before heating and a second diameter after heating.

22. An optical fiber filter, comprising:
a core portion;
a fiber grating formed at a selected location within the core portion;
a cladding portion surrounding the core portion; and
a protective coating surrounding the cladding portion, the protective coating formed by heating at least one polymer layer surrounding the cladding portion for a selected time at a selected temperature, the polymer layer having a first thickness and the protective coating having a second thickness less than the first thickness.

23. The optical fiber filter of claim 22, wherein the second thickness is approximately 10-20 microns.

24. A tunable fiber grating, comprising:
an optical fiber having a fiber grating having a first reflectance and a first end and a second end, the fiber grating formed within a core portion of the optical fiber, the core portion is surrounded by a cladding portion, and the cladding portion is surrounded by a protective coating formed by heating at least one polymer layer having a first thickness surrounding the cladding portion such that the coating has a thickness less than the first thickness;
a fixed mount adapted to receive and attach to a first portion of the optical fiber such that the fiber grating is not located within the fixed mount; and
a movable mount adapted receive and attach to a second portion of the optical fiber such that the fiber grating is not located within the movable mount and is located between the fixed mount and the movable mount, wherein moving the movable mount relative to the fixed mount induces strain in the optical fiber and the fiber grating has a second reflectance.

25. A method for mounting an optical fiber having a core portion, a cladding portion surrounding the core portion, and a protective coating surrounding the cladding portion, the protective coating formed by heating at least one polymer layer surround the cladding portion for a selected time at a selected temperature, the polymer layer having a first thickness and the protective coating having a second thickness less than the first thickness, comprising:
placing the optical fiber within a mount;
fixing the optical fiber within the mount using a mounting agent.

26. The method of claim 25, wherein fixing the optical fiber within the mount includes applying the fixing agent on at least one selected location on the protective coating of the optical fiber such that the fixing agent adheres the protective coating to the mount.

27. The method of claim 25, wherein fixing the optical fiber within the mount includes applying the fixing agent to at least one selected location on the protective coating of the optical fiber such that a portion of the optical fiber is hermetically sealed within the mount.

28. The method of claim 25, wherein the fixing agent is solder.

29. The method of claim 25, wherein the fixing agent is a low melting temperature glass.

30. The method of claim 25, wherein the fixing agent is a suitable adhesive.

31. A method for forming a composite structure incorporating an optical fiber, comprising:
providing a composite structure preform;
embedding an optical fiber having a core portion, a cladding portion, and a protective coating surrounding the cladding portion, the protective coating formed by heating at least one polymer layer surround the cladding portion for a selected time at a selected temperature, the polymer layer having a first thickness and the protective coating having a second thickness less than the first thickness, into the composite structure preform;
curing the composite structure preform.
